(19) United States
(12) Patent Application Publication
(10) Pub. No.: US 2004/0220853 A1
(43) Pub. Date: Nov. 4, 2004

(54) System and method for sales promotion

(76) Inventor: Hauke Schramm, Roetgen-Mulartshuette (DE)

Correspondence Address: Philips Corporation, Intellectual Property Department, P O Box 3001, New York, NY, 10510, US

(21) Appl. No.: 10/480,357

(22) PCT Filed: Jun. 19, 2002
(86) PCT No.: PCT/IB02/02248

(30) Foreign Application Priority Data
Jun. 19, 2001 (DE) 101 29 465.4
May 4, 2002 (DE) 102 20 017.3

(51) Int. Cl. G06F 17/60

(52) U.S. Cl. 705/14

(57) ABSTRACT

The invention relates to a sales promotion system and a method employing a pattern recognition component, which is so designed that

the pattern recognition component is used to recognize an input by a user of the sales promotion system,

and the sales promotion system is intended to perform a sales promotion procedure with the user as a function of the result produced by the recognition of the user input.

The invention relates to a system and method for sales promotion. In this case the term sales promotion covers all the measures and campaigns undertaken to promote and encourage the sales of products and services in the very widest sense. In particular, it also covers the area of advertising and canvassing, be it product or image advertising or canvassing, and the area of different sales incentives, be they in the form of discounts, rewards for customer loyalty, tie-in offers, or the like.

Sales promotion has traditionally required a high input of manual work, or in other words has been automated to only a small degree. Hence sales discussions are usually conducted directly, e.g. between an employee of the seller and a customer. In the case of canvassing activities too, at least the forms where the person canvassed is actively involved in the activities require a great deal of manual effort.

A well-known example of a case where the persons canvassed are actively involved is the slogan quiz. In this case, the person canvassed answers a question about a striking phase used to advertise the article in question, the so-called slogan. Possible ways in which the question can be put are for example “What is the X company's slogan?” or “Complete the following advertising slogan: “And then a . . . ”. These quiz questions are usually distributed to the persons canvassed via the printed media on postcards specially produced for the purpose and the persons canvassed can then answer the questions and send the postcards to the company doing the advertising.

It is true that the technical facilities available on the internet in particular have now provided certain partly or fully automated canvassing and/or selling systems. An example that may be mentioned here is the “Payback” system that has been introduced in Germany, which automatically gives the customer a certain discount on purchases from a company connected into the system, this discount being credited to the customer on his corresponding internet account in the form of so-called “Payback” points that can then be redeemed as prizes or also as cash. However, these systems are rigid in the way in which they have to be operated, i.e. they do not provide the customer (or the individual employee of the vendor) with any facilities for individual arrangements. The discounts for example are fixed and thus cannot be negotiated in an individual case. Also, if the customer has any opportunity at all of interacting with the system, it is only limited and as a result the essential effect of interaction between vendor and customer, the feeling of “live” interaction, is largely lost.

It is therefore an object of the invention to provide a system and method for sales promotion that on the one hand are inexpensive but on the other hand allow the sales promotion to be highly flexible and interactive.

This object is achieved on the one hand by

a sales promotion system having a pattern recognition component, which is so designed that

the pattern recognition component is used to recognize an input by a user of the sales promotion system,

and the sales promotion system is intended to perform a sales promotion operation with the user as a function of the result produced by the recognition of the user input

and on the other hand by

a sales promotion method having the steps of:

recognizing inputs by a user of the sales promotion system by means of a pattern recognition component

and performing a sales promotion operation with the user as a function of the result produced by the recognition of the user input.

By the use of pattern recognition, the user of the system, i.e. the potential customer, is given an opportunity of interacting with the sales promotion system in a natural way. For example, in the canvassing area the advertising slogans or product names asked for by the system can simply be spoken into a microphone, whereupon the system uses speech recognition to convert the spoken input into text. In a similar way, the person canvassed can hum theme tunes or can even input graphic representations such as the logos of companies or products via a graphics console or a touch screen.

As an inducement to a user to interact with a sales promotion system in the form of, for example, a canvassing system, the canvassing system may promise him a reward. That is to say that if the canvassing system recognizes a pattern input by the person canvassed as the one it was asking about, or in other words if for example a spoken statement that is input is recognized by the speech recognition system as the advertising slogan that was being asked for, the canvassing system checks whether the person canvassed is to be given a reward. It is possible in this case for a reward of this kind to always be given if the pattern recognized corresponds to the one asked for. However, it is also possible for the giving or the reward to be made dependent on further criteria. A reward may for example only be given in a certain percentage of the cases where a pattern is recognized as the correct one. If the canvassing campaign is related to a purchasing operation performed by the person canvassed, the size of the reward may also be made dependent on the value of the purchase. In canvassing campaigns where there is no direct correlation with purchases by the person canvassed, there is the possibility of the value of the reward being derived from the value of the goods or services advertised.

Among the things that may be offered as rewards are the following:

a product and/or a service and/or

a price reduction on a product and/or on a service and/or

a temporally restricted use of a game and/or

a participation in a draw and/or

a publication on a list of winners.

In this way a telephone company for example may offer free or reduced-price telephone calls as a reward, or a film company may offer free or reduced-price visits to cinemas.

In this case, the canvassing system may, as the person canvassed chooses, cause him to receive the reward intended for him directly or else may provide him with evidence in return for which the person canvassed can obtain the reward elsewhere. In this way the system may for example carry out a draw directly or else may give the person canvassed a credit voucher, in return for the surrender of which he will receive from certain businesses a product and/or a service or a price reduction on a product and/or a service. Rather than a printed credit voucher, the system may also give the person canvassed an entitlement number against which, when quoted, the product and/or service will then be obtainable.

The user may also interact with other forms of sales promotion system according to the invention in a similar way to that in which he interacts with the canvassing system described above. The input media available to the user are for example, speech, tunes, writing, drawings or the like, which are received via a microphone, a touch screen, a graphics console or the like and fed to the system's pattern recognition facilities. Depending on the design, the system output may be supplied via one or more media, for example as speech or other acoustic means via a loudspeaker, as text or graphics via a display or in some other suitable form.

Whereas in the case of the canvassing system described the system may for example cause an appropriate reward to be given immediately on recognition of a slogan asked for, a sales promotion system according to the invention may also be equipped with other components. In this way, further dialoguing and conclusion-inducing components may be required to enable sales dialogs to be carried on reliably, which components allow the user to be asked for information that is missing, allow statements that have not been understood to be clarified and/or allow the sales promotion system to be given the opportunity to itself take the initiative. In this way the system may for example itself offer sale incentives that go beyond those asked for directly by the customer.

Interaction between a user and a sales promotion system may take place in this way in a similar way to that in which it might take place between the user and, for example, an employee of a vendor. There may for example be negotiations as to a discount (“You could at least offer me a discount on that.”), in which case questions such as customer loyalty (“I've been a customer of yours for 10 years.” or “I've been buying from you for 2 years now and I've always been very happy.”), the size of the purchase (“And after all, what I'm buying from you now is worth more than 500 Euros”), mention of what is on offer from competitors (“Your competition is offering the same thing but for 100 Euros.”) and the like may be considered. Or the system may make a tie-in offer to the customer: “If you buy product A you will get product B as a free gift” or “For a period of one month, buying product A entitles you to a 10% discount on all our goods in category B.”

The user inputs intended for the sales promotion system may be made either to a public terminal such as an automatic vending machine for example or to a private device belonging to the user, such as a telephone (mobile or fixed network), a PC or laptop, a PDA or the like for example. Depending on the particular embodiment, the sales promotion system may be incorporated in the input terminal or else the user inputs may be transmitted to it over a network. Incorporation in an automatic vending machine in particular is an easy way of supplying the user with the product directly or, in the case of a canvassing campaign, with a reward if there is one. Transmission over a network, e.g. a telephone network, the internet or an intranet, allows a sales promotion system according to the invention to be installed at a centralized point and hence in such a way that it is easy to maintain and install.

To allow the sales promotion procedures available from the system to be managed, suitable memories and management components are provided on the system that allow vendors or persons authorized by them to, for example, amend or delete existing sales promotion procedures from the system or to add new ones. It may also be advantageous for the sales promotion procedures to be provided with periods of validity so that any time limits set can be allowed for automatically by the system. For such management processes, it is once again particularly advantageous if the access to the system for this purpose can take place over a network, such as the internet for example, to which the individual vendors then have, for example, direct access.

In a further embodiment, the sales promotion system acquires data on the use made of it and stores this data for subsequent evaluation. In this way, important information can for example be obtained on consumer behavior and on the opinions users have about individual companies or products, or the data can be used for billing purposes for the providers of the sales promotion procedures who make use of the system

These and other aspects of the invention are apparent from and will be elucidated with reference to the embodiments described hereinafter.

In the drawings:

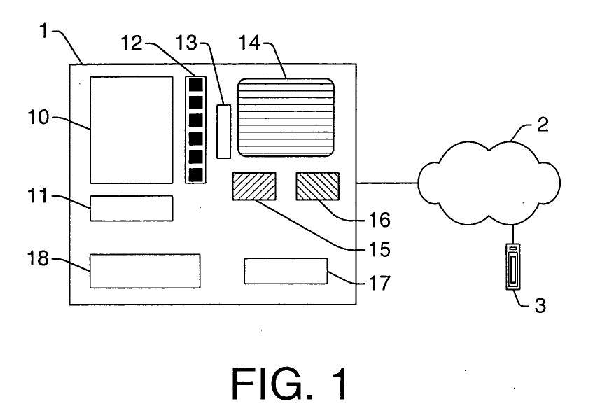

FIG. 1 shows an embodiment of a sales promotion system according to the invention in the form of a canvassing system.

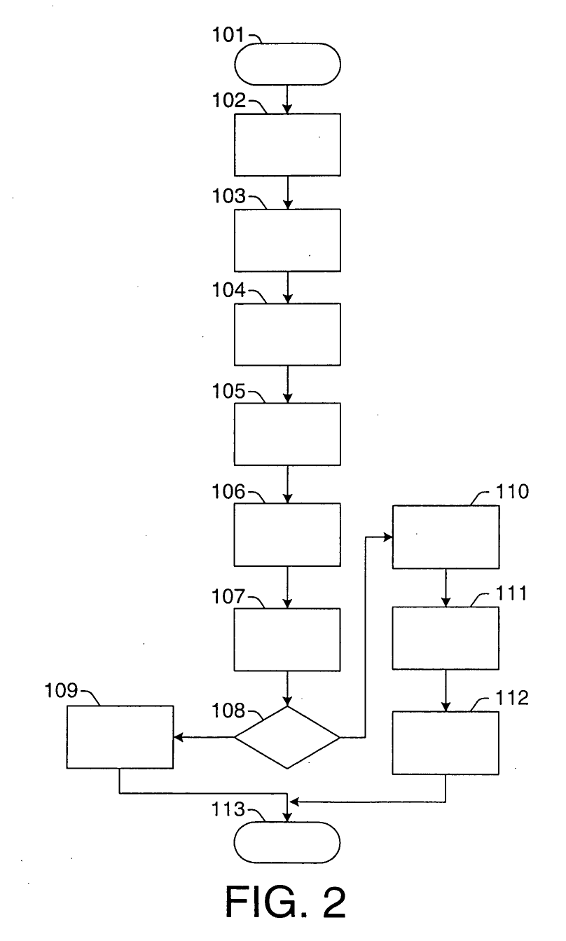

FIG. 2 is a flow chart showing the procedure followed in an interaction by a user with a sales promotion system according to the invention, which system is in the form of an interactive canvassing system.

FIG. 1 shows in diagrammatic form an embodiment of a sales promotion system according to the invention in the form of a canvassing system. An automatic vending machine 1 is connected to a server 3 via a network 2, e.g. the internet or a private network. The automatic vending machine 1 has a goods display compartment 10, a goods output compartment 11, a key pad 12, a cash insertion slot 13, a display 14, a loudspeaker 15, a microphone 16, a printing unit 17 and a processing unit 18.

The sale of a product from the automatic vending machine 1 takes place in a known manner by finding the product that is presented for viewing in the goods display compartment 10, pressing the appropriate key on the key pad 12, inserting the appropriate amount of cash in the cash insertion slot 13 and then receiving the product selected from the goods output compartment 11. Information, e.g. on how to operate the automatic vending machine 1, can be given to a customer by means of the display 14 and the loudspeaker 15.

In order now to direct interactive canvassing at the customer using the automatic vending machine 1, the customer is requested via the loudspeaker 15 and/or the display 14 to, for example, complete the advertising slogan of a company whose goods are offered for sale by the automatic vending machine 1. Rather than simply asking for the advertising slogan to be completed, the system could also distort the slogan in some way, e.g. play it slower or faster or at variable speed or wholly or partly backwards in order then to ask the user what slogan he recognized.

The customer's answer is picked up by the microphone 16 and after local processing by the processing unit 18 is passed on via the network 2 to the server 3. In the present embodiment of a canvassing system, the server 3 performs the function of controlling the interaction with the customer. The local processing unit 18 merely performs certain encoding functions and the requisite local functions such as driving the input/output units in relation to the customer. The central server 3 may process the canvassing interactions for a plurality of automatic vending machines 1 in this case.

The local processing unit 18 may for example subject the customer's answer picked up by the microphone 16 to digital-to-analog conversion. To save transmission bandwidth on the network 2, it may also carry out compression of the audio signal by performing some or all of the steps that the signal processing required for the speech recognition of the answer involves, such as the so-called feature analysis. The processing unit 18 then transmits the features over the network 2 to the central server 3, which performs the speech recognition of the answer and decides what further actions the canvassing system is to take.

The embodiment of a canvassing system described here that has a central server 3 offers not only the advantage that the system is easily maintainable but above all advantages in terms of load handling because the server 3 is able to operate a plurality of automatic vending machines 1. If for any reason it should be impossible or undesirable for a distributed system of this kind to be operated, it is also possible to implement self-contained automatic vending machines 1 by incorporating the full functionality of the server 3 in the local processing unit 18. On the other hand, it would however also be possible for other terminals to make contact with the server 3 over the network 2 in order to conduct the advertising dialog. If the server 3 is suitably designed to for example use the XML interfaces that are standard on the internet, then a terminal at the customer end, e.g. even a PC that has internet access, can be used for the canvassing dialog. For this purpose, the attention of a person canvassed may for example be drawn to the canvassing system by an advertising banner on a much-visited internet site and the person may enter into the canvassing dialog with the server 3 by clicking on the banner.

As described here, where the canvassing system is taken as an example, other embodiments of sales promotion systems according to the invention may also be offered by way of an automatic vending machine or the like. In the embodiment having a central server 3 that can be reached via a network 2, the server 3 may also advantageously be used for managing the sales promotion procedures and for acquiring the user data for the system and, where required, also for applying further processing to it and for passing it on. In this way, by means of, for example, access control mechanisms such as passwords, transactions numbers or chip cards, facilities for protected access over the network 2 to the server 3 may be created for the providers of sales promotion procedures or their authorized agents, who make the functionalities required available to the group of people concerned in some convenient way.

FIG. 2 is a flow chart showing the procedure followed in an interaction by a user with a sales promotion system according to the invention in the form of an interactive canvassing system. It also elucidates certain details of the operating processes within the sales promotion system. What is taken as a basis is the scenario shown in FIG. 1, i.e. an automatic vending machine 1, which in this case sells cigarettes.

After being activated in the starting box 101, the interactive canvassing system waits for a customer to make contact. In box 102 of the process, a customer buys a packet of cigarettes of a given brand from the automatic vending machine 1. In box 103, the processing unit 18 reports this buying operation to the server 3, which analyzes the buying operation in box 104. It is assumed to be known from market surveys that purchasers of this brand of cigarette are also potential purchasers of designer lighters of sophisticated design. This being the case, the server 3 decides in box 104 that it wants to enter into a canvassing dialog with the customer to offer a particular designer lighter called L1. It therefore directs the processing unit 18 to invite the customer to engage in a canvassing dialog and to ask him the question, which of the three designer lighters called L1, L2 and L3 has been awarded a prize for design.

In box 105, the processing unit 18 uses the display 14 and the loudspeaker 15 to invite the customer to take part in the canvassing quiz and to ask him the question, which of the three designer lighters called L1, L2 and L3 has been awarded a prize for design. For this purpose the server 3 may also supply additional informative material on the three lighters, such as photos of the lighters, certain technical details and/or recommended retail prices for them. This information too can be shown to the customer, e.g. by means of the display 14.

In box 106 the customer answers the question about the lighter that has been awarded a prize for design by saying one of the three names L1, L2 or L3. This answer is picked up by the microphone 16 and fed to the processing unit 18 as an audio signal. The processing unit 18 can then undertake an analog-to-digital conversion of the audio signal and also, even at this stage, a feature analysis in preparation for the speech recognition that is to follow on the server 3, which results in the audio signal being compressed and hence in transmission capacity being saved on the network 2.

In box 107, the features are then transmitted over the network 2 to the server 3, which performs speech recognition on the customer's answer. Speech recognition of this kind may for example be carried out with only the three alternatives L1, L2 and L3 available for recognition, because the customer is in fact intended to select one of these three alternatives. In the decision box 108, the server 3 then checks whether the result of its recognition process matches the desired answer L1.

If it does not, the customer is told in box 109 that unfortunately his answer is wrong and that it was lighter L1 that won the prize for design. At the same time the customer may also be given other details such as the time of the award and the nature of the prize for example. Finally, the canvassing system takes its leave of the customer by wishing him more luck in the future and the canvassing interaction ends with the end box 113.

If on the other hand the check in box 108 shows that the answer given matches the desired answer L1, the server 3 determines a reward for the customer in box 110, such as a discount on the purchase price of an L1 lighter. In box 1 a credit voucher for this purpose is printed out by the printing unit 17 and is passed to the customer by way of an appropriate output compartment. In box 112, the canvassing system takes its leave of the customer and the canvassing interaction once again comes to an end at the end box 113.

The interactive canvassing system described may be further developed in, for example, the following way: In box 110, instead of only offering the customer a discount in the event of a possible future purchase of an L1 lighter, the system may also directly offer the customer the actual purchase, in which case a further sales dialog may also be conducted. If the customer agrees to buy an L1 lighter, the system may also for example ask for details of the customer's address to have the L1 lighter sent to him. Payment may be made on receipt against an invoice or may also be made directly to the automatic vending machine. There are also other variants that are feasible in this case however.

1. A sales promotion system having a pattern recognition component, which is so designed that
the pattern recognition component is used to recognize an input by a user of the sales promotion system,
and the sales promotion system is intended to perform a sales promotion procedure with the user as a function of the result produced by the recognition of the user input.

2. A sales promotion system as claimed in claim 1, characterized in that
the pattern recognition component is a speech recognition system and
the user input is a spoken statement.

3. A sales promotion system as claimed in claim 1, characterized in that the sales promotion procedure is a canvassing campaign in which the sales promotion system is intended to ask the user to input
an advertising slogan and/or
the name of a product that is being advertised and/or
a logo of a company and/or of a product that is being advertised and to check, as a function of the result produced by the recognition of the user input, whether the user is to be given a reward, particularly in the form of
a product and/or a service and/or
a price reduction on a product and/or on a service and/or
a temporally restricted use of a game and/or
a participation in a draw and/or
a publication on a list of winners.

4. A sales promotion system as claimed in claim 1, characterized in that the sales promotion procedure is a discount campaign in which the sales promotion system is intended to check, as a function of the result produced by the recognition of the user input, whether the user is to be offered a discount on a product or a service and if so of what size.

5. A sales promotion system as claimed in claim 1, characterized in that the sales promotion procedure is a tie-in offer in which the sales promotion system is intended to check, as a function of the result produced by the recognition of the user input, whether a tie-in offer, in which the purchase of a product or a service is connected with a further action, is to be made to the customer and if so of what kind.

6. A sales promotion system as claimed in claim 1, characterized in that the sales promotion system is coupled to an automatic vending machine that is intended for the user inputs.

7. A sales promotion system as claimed in claim 1, characterized in that the sales promotion system is connected to a network that is intended to transmit the user inputs to the sales promotion system.

8. A sales promotion system as claimed in claim 1, characterized in that the sales promotion system can be accessed, in particular via a network, for managing and in particular for entering, deleting or amending sales promotion procedures offered by the system.

9. A sales promotion system as claimed in claim 1, characterized in that the sales promotion system is intended to acquire data on use relating to the sales promotion procedures, particularly for charging purposes.

10. A sales promotion method having the steps of
recognizing inputs by a user of the sales promotion system by means of a pattern recognition component
and performing a sales promotion procedure with the user as a function of the result produced by the recognition of the user input.
